(19) United States
(12) Patent Application Publication
(10) Pub. No.: US 2026/0298284 A1
(43) Pub. Date: Oct. 1, 2026

(54) BALL JOINT WITH HIGH TENSILE STRENGTH

(71) Applicant: JASON CO., LTD., PINGTUNG COUNTY (TW)

(72) Inventor: HUNG-YU CHEN, PINGTUNG COUNTY (TW)

(21) Appl. No.: 19/459,293

(22) Filed: Jan. 26, 2026

(30) Foreign Application Priority Data
Mar. 26, 2025 (TW) 114203000

(51) Int. Cl. F16C 11/06

(52) U.S. Cl. CPC F16C 11/0628

(57) ABSTRACT

A ball joint with high tensile strength includes a bearing socket, a ball stud, and a base cap which includes an outer cap unit having an accommodation room and a bending portion, an inner cap unit installed in the accommodation room, and a bottom cap unit situated at the bottom of the outer cap unit and fixed by the bending portion. The inner cap unit and the outer cap unit are made of dissimilar materials. A tensile strength of the inner cap unit is greater than a tensile strength of the outer cap unit, thereby improving the whole tensile strength and the service life of the ball joint. When the cap units are provided to assemble ball joints with different specifications, the outer cap unit is manufactured and stored with a standardized dimension, while the inner cap unit is manufactured with a modifiable dimension, thereby reducing manufacturing and inventory costs.

### BACKGROUND OF THE INVENTION

### 1. Field of the Invention

This invention relates to a ball joint and relates particularly to a ball joint with high tensile strength.

### 2. Description of the Related Art

Ball joint is one of the essential components using in machines or vehicles for connecting steering or suspension apparatuses. For example, when the ball joint is applied to a vehicle, it is adapted to connect a vehicle body and a suspension apparatus or to connect a steering apparatus and wheels, thereby achieving a universal rotation effect. Thus, the ball joint is widely used as a linking hinge.

Referring to FIGS. 1 and 2, a conventional ball joint 1 includes a base cap 11, a ball stud 12 pivotally installed on the base cap 11, a bearing socket 13 disposed between the ball stud 12 and the base cap 11, and a bottom cap unit 14 fixed to the base cap 11 and in contact with the bearing socket 13. The ball stud 12 has a ball portion 121 pivotally disposed on the bearing socket 13 and a shaft portion 122 extended outwards from the ball portion 121 and disposed outside of the base cap 11. When the ball portion 121 is pivotally installed on the bearing socket 13, the shaft portion 122 is situated outside of the bearing socket 13. An accommodation room 111 is formed inside of the base cap 11 and adapted to accommodate the ball stud 12 and the bearing socket 13. After the ball portion 121 is pivotally engaged with the bearing socket 13, the ball portion 121 and the bearing socket 13 are placed into the accommodation room 111. After the ball stud 12 is assembled properly to allow the shaft portion 122 to be exposed outside of the base cap 11, the bottom cap unit 14 is placed into the accommodation room 111 of the base cap 11 so that the bottom cap unit 14 is situated at a bottom of the base cap 11. A bottom peripheral edge of the base cap 11 is bent to form a bending portion 112. The bottom cap unit 14 is pressed by the bending portion 112. Thus, the bearing socket 13 and the ball portion 121 are tightly confined in the accommodation room 111 of the base cap unit 11 by the bending portion 112.

However, the base cap 11 is made of aluminum alloy. The bearing socket 13 is only fixed by the bending portion 112, and thus the bearing socket 13 is easily moved caused by the rotation of the ball portion 121 of the ball stud 12 when the ball stud 12 is operated. Therefore, the bearing socket 13 rubs against the base cap 11, and that will result in improper abrasion and reduce the service life of the ball joint 1 greatly.

The ball cap 11 can be made of a better metal material with a greater strength in order to improve the wear resistance and the tensile strength of the ball joint 1. Although that can improve the performance the ball joint 1, the price of the ball joint 1 is raised owing to the increasing manufacturing costs caused by using the better metal material which is more expensive. The market competitiveness and the purchase intention are reduced. Therefore, it is not satisfactory to change the material of the ball cap 11. Further, ball joints 1 are provided with different specifications in order to be engaged with different components. Different molds should be applied and customized according to the requirements of different customers to thereby manufacture ball caps 11 with different dimensions for assembling ball joints 1 with different specifications, and that will result in an increase of manufacturing and inventory costs and occupy a large space for storage. Hence, the deficiencies require to be improved.

### SUMMARY OF THE INVENTION

The object of this invention is to provide a ball joint with high tensile strength capable of increasing a tensile strength, extending the service life, and reducing manufacturing and inventory costs.

The ball joint with high tensile strength of this invention comprises a base cap, a ball stud pivotally installed on the base cap, and a bearing socket installed between the base cap and the ball stud. The ball stud includes a ball portion pivotally installed in the bearing socket and a shaft portion extended outwards from the ball portion and located outside of the base cap. The base cap includes an outer cap unit defining an accommodation room in an interior, an inner cap unit installed in the accommodation room and adapted to accommodate the bearing socket, and a bottom cap unit installed between a bottom of the outer cap unit and the inner cap unit. The outer cap unit includes an inner cap wall formed in an interior and defining the accommodation room and a bending portion formed on a bottom peripheral edge. The inner cap unit includes an outer cap wall in contact with the inner cap wall of the outer cap unit and a receiving space enclosed by the inner cap wall to accommodate the bearing socket. The bottom cap unit is in contact with the inner cap unit when the bottom cap unit and the inner cap unit are properly positioned in the accommodation room of the outer cap unit so that the receiving space is covered and sealed by the bottom cap unit. The outer cap unit and the inner cap unit are made of dissimilar materials. A tensile strength of the outer cap unit is less than a tensile strength of the inner cap unit. After the inner cap unit is placed into the accommodation room, the ball portion and the bearing socket are engaged together and placed into the receiving space of the inner cap unit. The bottom cap unit is then placed into the accommodation room, situated at the bottom of the outer cap unit, and pressed by the bending portion which is formed by bending the bottom peripheral edge of the outer cap unit so that the ball stud and the bearing socket are confined in the receiving space stably. The inner cap unit is made of a dissimilar metal material with a high tensile strength, thereby increasing the whole tensile strength of the ball joint. When the base cap is provided to be engaged with ball portions of ball joints with different specifications, the outer cap unit is manufactured with a standardized dimension, while the inner cap unit is manufactured with a modifiable dimension. Thus, manufacturing and inventory costs are reduced.

Preferably, the inner cap wall of the outer cap unit includes a first contact wall portion provided with a first inner surface, a second contact wall portion provided with a second inner surface, and an engaging wall portion connected to the first contact wall portion and the second contact wall portion and provided with a third inner surface so that the third inner surface is situated between the first inner surface and the second inner surface. The outer cap wall of the inner cap unit includes a first fitting wall portion provided with a first outer surface, a second fitting wall portion provided with a second outer surface, and a positioning wall portion connected to the first fitting wall portion and the second fitting wall portion and provided with a third outer surface so that the third outer surface is situated between the first outer surface and the second outer surface. The first fitting wall portion and the second fitting wall portion respectively abut against the first contact wall portion and the second contact wall portion so that the first outer surface and the second outer surface are respectively in contact with the first inner surface and the second inner surface. The positioning wall portion abuts against the engaging wall portion so that the third outer surface is in contact with the third inner surface.

### BRIEF DESCRIPTION OF THE DRAWINGS

FIG. 1 is an exploded view showing a conventional ball joint;

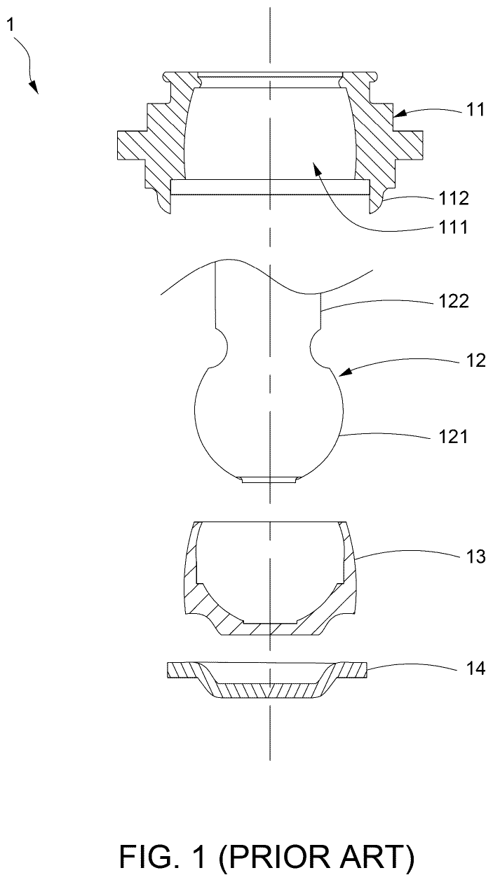

FIG. 2 is a cross-sectional view showing a conventional ball joint;

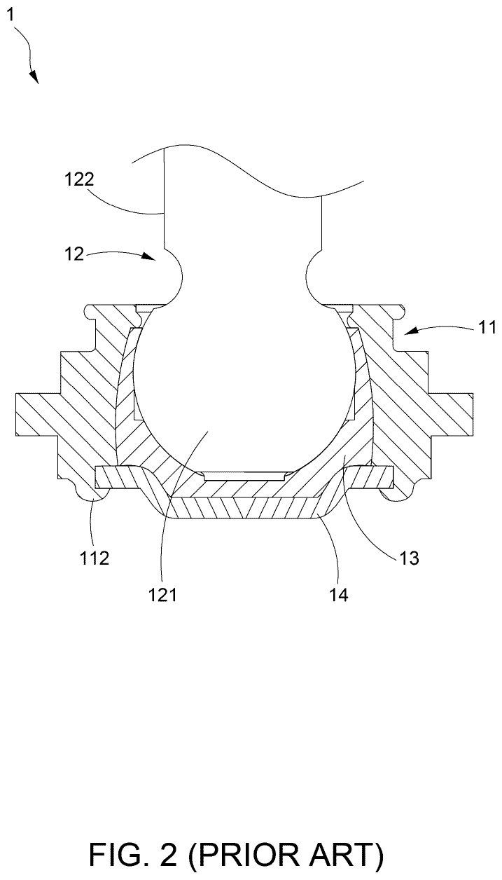

FIG. 3 is an exploded view showing a first preferred embodiment of this invention;

FIG. 4 is a cross-sectional view showing the first preferred embodiment of this invention;

FIG. 5 is an exploded view showing a second preferred embodiment of this invention; and

FIG. 6 is a cross-sectional view showing the second preferred embodiment of this invention.

### DETAILED DESCRIPTION OF THE PREFERRED EMBODIMENTS

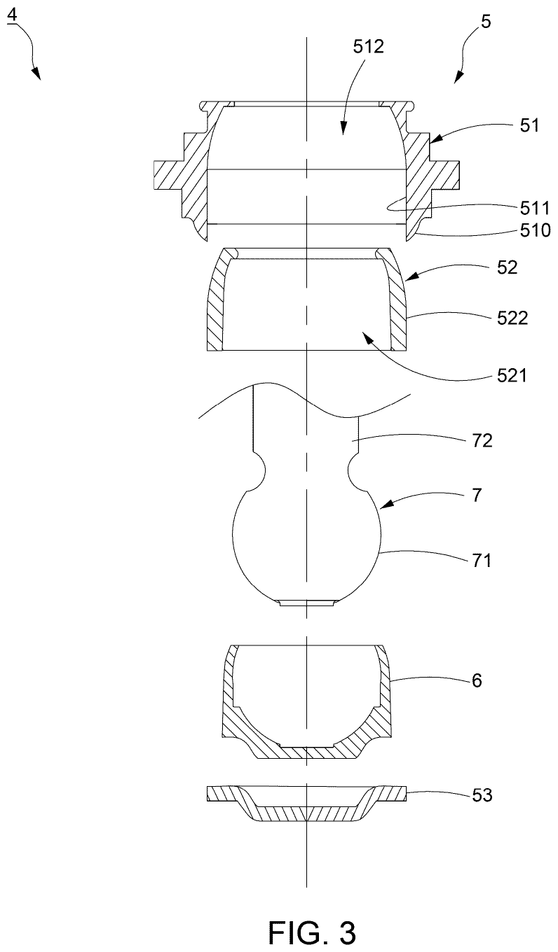

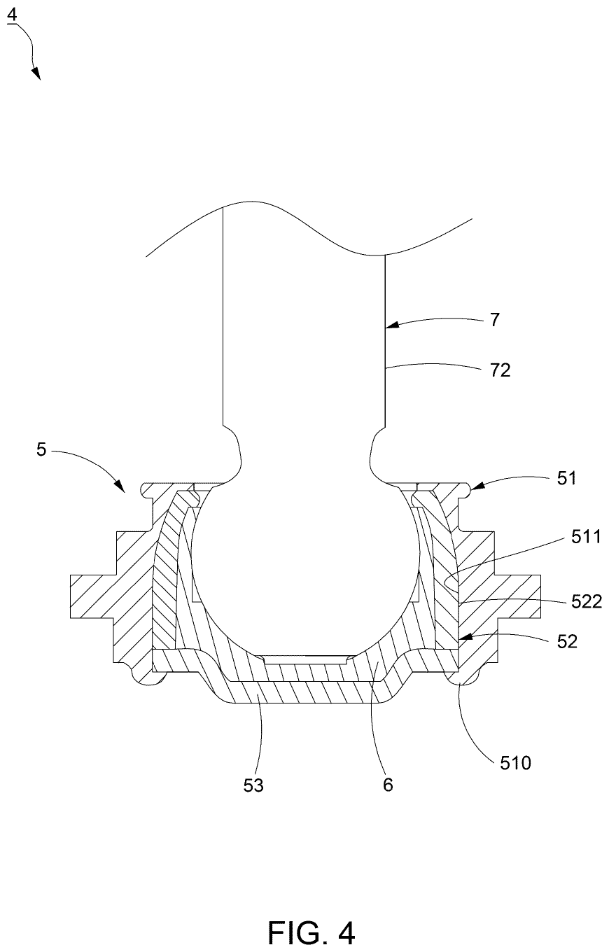

Referring to FIGS. 3 and 4, a first preferred embodiment of a ball joint with high tensile strength 4 of this invention is disclosed. The ball joint 4 is adapted to be used in a vehicle suspension system (not shown) such as rack end, anti-roll bar, control arm and so on. The ball joint 4 comprises a base cap 5, a bearing socket 6 disposed in the base cap 5, and a ball stud 7 pivotally disposed in the bearing socket 6 and partially extended outside of the base cap 5. The ball stud 7 includes a ball portion 71 pivotally installed in the bearing socket 6 and a shaft portion 72 extended outwards from the ball portion 71 and situated outside of the base cap 5.

The base cap 5 includes an outer cap unit 51, an inner cap unit 52 engaged with the outer cap unit 51 and defining a receiving space 521 in an interior, and a bottom cap unit 53 disposed between the bottom of the outer cap unit 51 and the inner cap unit 52, i.e., at a bottom of the outer cap unit 51 and adapted to seal the inner cap unit 52. The bottom cap unit 53 is in contact with the inner cap unit 52 when the bottom cap unit 53 and the inner cap unit 52 are placed in the outer cap unit 51. The receiving space 521 is enclosed by the interior of the inner cap unit 52 to accommodate the bearing socket 6. In this preferred embodiment, the outer cap unit 51 is made of aluminum alloy. A bending portion 510 is disposed on a bottom peripheral edge of the outer cap unit 51. An inner cap wall 511 is formed inside of the outer cap unit 51. An accommodation room 512 is enclosed by the inner cap wall 511 to accommodate the inner cap unit 52. The outer cap unit 51 and the inner cap unit 52 are made of dissimilar materials which are different from each other. A tensile strength of the inner cap unit 52 is greater than a tensile strength of the outer cap unit 51. In this preferred embodiment, the inner cap unit 52 is made of iron. Therefore, the inner cap unit 52 can be manufactured by a casting process or a direct turning process according to needs. The inner cap unit 52 includes an outer cap wall 522 in contact with the inner cap wall 511 of the outer cap unit 51. The receiving space 521 is formed to match a shape of the bearing socket 6 so that the bearing socket 6 is accommodated in the receiving space 521 properly. The bottom cap unit 53 is pressed by the bending portion 510 formed by bending the bottom peripheral edge of the outer cap unit 51 so that the bearing socket 6 is placed in position.

Referring to FIGS. 3 and 4, during the installation of the ball joint 4, the inner cap unit 52 is placed into the accommodation room 512 from the bottom of the outer cap unit 51. Meanwhile, the ball portion 71 of the ball stud 7 is placed in the bearing socket 6 and the shaft portion 72 of the ball stud 7 is exposed outside of the bearing socket 6 so that the ball stud 7 is engaged with the bearing socket 6 properly. The bearing socket 6 and the ball stud 7 are placed into the receiving space 521 of the inner cap unit 52 after the bearing socket 6 and the ball stud 7 are engaged. Namely, the shaft portion 72 is penetrated through the receiving space 521 to be exposed outside of the base cap 5 and to allow the bearing socket 6 and the ball portion 71 to be accommodated in the receiving space 521. After that, the bottom cap unit 53 is installed at the bottom of the outer cap unit 51 so that the receiving space 521 is sealed by the bottom cap unit 53. The bottom peripheral edge of the outer cap unit 51 is then bent to form the bending portion 51. The bending portion 510 presses the bottom cap unit 53 so that the inner cap unit 52 and the bearing socket 6 are confined within the accommodation room 512. Because the inner cap unit 52 is provided with better wear resistance and increasing tensile strength, it can bear the abrasion caused by the rotation of the bearing socket 6 when the ball stud 7 is operated and prevent the bearing socket 6 from directly rubbing against the outer cap unit 51, thereby preventing a gap formed between the outer cap unit 51 and the bearing socket 6 caused by the abrasion and extending the service life of the ball joint 4 effectively. The inner cap unit 52 is detachably engaged with the outer cap unit 51, and that allows the outer cap unit 51 to be manufactured and stored with a standardized dimension and allows the inner cap unit 52 to be manufactured with a modifiable dimension when the base cap 5 is provided to assemble ball joints 4 with different specifications, thereby reducing manufacturing and inventory costs greatly and increasing the market competitiveness effectively.

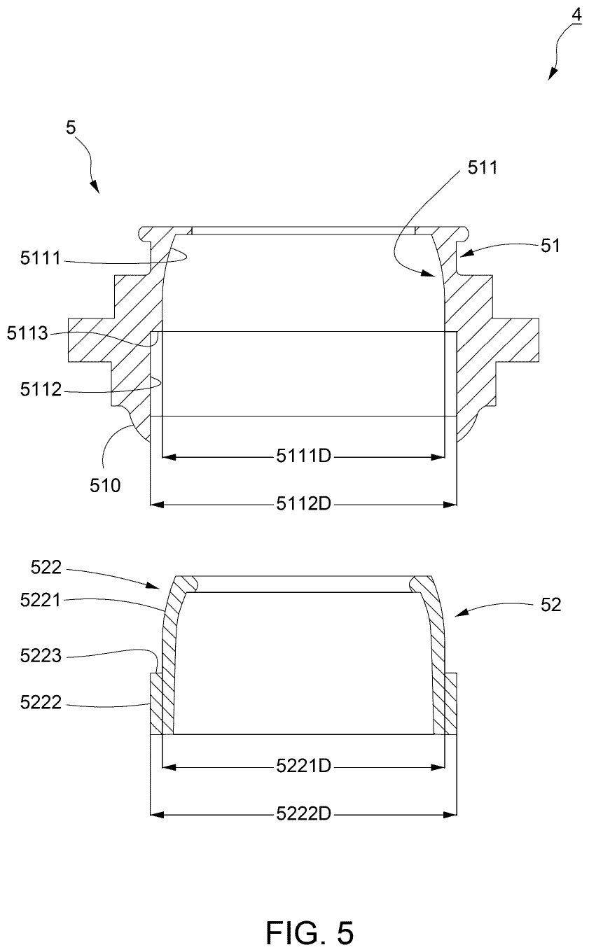

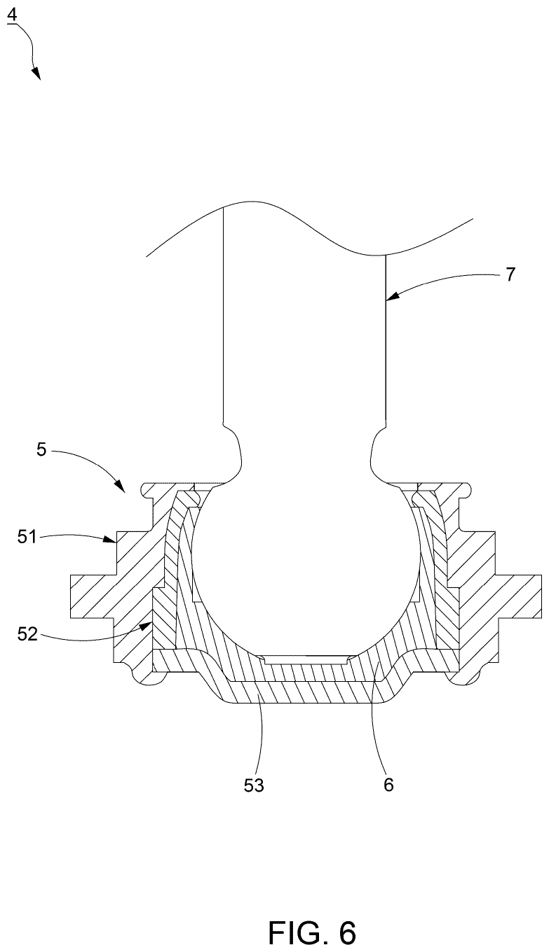

Referring to FIGS. 5 and 6 show a second preferred embodiment of the ball joint with high tensile strength 4 of this invention. The correlated elements and the concatenation of elements, the operation and objectives of the second preferred embodiment are the same as those of the first preferred embodiment. This embodiment is characterized in that the inner cap wall 511 of the outer cap unit 51 includes a first contact wall portion 5111 provided with a first inner surface, a second contact wall portion 5112 provided with a second inner surface, and an engaging wall portion 5113 connected to the first contact wall portion 5111 and the second contact wall portion 5112 and provided with a third inner surface so that the third inner surface is situated between the first inner surface and the second inner surface. A maximum diameter 5111D of the first contact wall portion 5111 is less than a maximum diameter 5112D of the second contact wall portion 5112. The outer cap wall 522 of the inner cap unit 52 includes a first fitting wall portion 5221 provided with a first outer surface, a second fitting wall portion 5222 provided with a second outer surface, and a positioning wall portion 5223 connected to the first fitting wall portion 5221 and the second fitting wall portion 5222 and provided with a third outer surface so that the third outer surface is situated between the first outer surface and the second outer surface. A maximum diameter 5221D of the first fitting wall portion 5221 is less than a maximum diameter 5222D of the second fitting wall portion 5222. The first fitting wall portion 5221 and the second fitting wall portion 5222 respectively abut against the first contact wall portion 5111 and the second contact wall portion 5112 so that the first outer surface and the second outer surface are respectively in contact with the first inner surface and the second inner surface. The positioning wall portion 5223 abuts against the engaging wall portion 5113 so that the third outer surface is in contact with the third inner surface. During the installation of the ball joint 4, the first contact wall portion 5111 and the second contact wall portion 5112 of the outer cap unit 51 are engaged with the first fitting wall portion 5221 and the second fitting wall portion 5222 of the inner cap unit 52 quickly. When the ball stud 7 is operated to cause a pulling force acting on the inner cap unit 52 to move the inner cap unit 52 toward the shaft portion 72, the engaging wall portion 5113 assists in supporting and fixing the positioning wall portion 5223 so that the inner cap unit 522 is prevented from being moved, thereby improving the tensile strength of the ball joint 4.

To sum up, the ball joint with high tensile strength of this invention takes advantages that the base cap includes the outer cap unit, the inner cap unit, and the bottom cap unit. The inner cap unit is made of the dissimilar material provided with great tensile strength, thereby improving the tensile strength of the ball joint. When the base cap is provided to assemble ball joints with different specifications, the outer cap unit is manufactured with a standardized dimension and the inner cap unit is manufactured with a modifiable dimension so that the base cap can be engaged with the ball stud by only changing the dimension of the inner cap unit, thereby reducing manufacturing costs.

While the embodiments of this invention are shown and described, it is understood that further variations and modifications may be made without departing from the scope of this invention.

What is claimed is:

1. A ball joint with high tensile strength comprising a base cap, a bearing socket disposed in said base cap, and a ball stud pivotally disposed on said bearing socket and partially disposed outside of said base cap, wherein said ball stud includes a ball portion pivotally disposed on said bearing socket and a shaft portion extended outwards from said ball portion and disposed outside of said base cap;
wherein said base cap includes an outer cap unit, an inner cap unit engaged with said outer cap unit and defining a receiving space in an interior, and a bottom cap unit situated at a bottom of said outer cap unit and adapted to seal said inner cap unit, with said inner cap unit being situated in said outer cap unit, and said bottom cap unit being in contact with said inner cap unit, said receiving space being enclosed by said interior of said inner cap unit to accommodate said bearing socket, wherein said outer cap unit and said inner cap unit being made of dissimilar materials, a tensile strength of said inner cap unit being greater than a tensile strength of said outer cap unit, an interior of said outer cap unit including an inner cap wall, an accommodation room being enclosed by said inner cap wall to accommodate said inner cap unit, said inner cap unit including an outer cap wall in contact with said inner cap wall of said outer cap unit, said receiving space being adapted to accommodate said bearing socket and being covered by said bottom cap unit, said bottom cap unit being pressed by a bending portion caused by bending said outer cap unit so that said bearing socket is placed in position, wherein after said inner cap unit is positioned in said accommodation room of said outer cap unit, said bending portion presses said bottom cap unit to confine said bearing socket in said receiving space stably.

2. The ball joint with high tensile strength according to claim 1, wherein said inner cap wall of said outer cap unit includes a first contact wall portion provided with a first inner surface, a second contact wall portion provided with a second inner surface, and an engaging wall portion connected to said first contact wall portion and said second contact wall portion and provided with a third inner surface so that said third inner surface is situated between said first inner surface and said second inner surface, said outer cap wall of said inner cap unit including a first fitting wall portion provided with a first outer surface, a second fitting wall portion provided with a second outer surface, and a positioning wall portion connected to said first fitting wall portion and said second fitting wall portion and provided with a third outer surface so that said third outer surface is situated between said first outer surface and said second outer surface, said first fitting wall portion and said second fitting wall portion respectively abutting against said first contact wall portion and said second contact wall portion so that said first outer surface and said second outer surface are respectively in contact with said first inner surface and said second inner surface, said positioning wall portion abutting against said engaging wall portion so that said third outer surface is in contact with said third inner surface.
